(19) United States
(12) Patent Application Publication
(10) Pub. No.: US 2008/0165109 A1
(43) Pub. Date: Jul. 10, 2008

(54) LIQUID CRYSTAL DISPLAY AND METHOD FOR ELIMINATING AFTERIMAGE THEREOF

(75) Inventors: Soong-Yong Joo, Seongnam-si (KR); Jung-Sun Lee, Gwangju- si (KR); Suk-Ki Jung, Suwon-si (KR); Dong-Yub Lee, Siheung-si (KR); Cheol Min Kim, Seoul (KR); Tae-Hyeong Park, Yongin-si (KR); Joon-Ha Park, Busan (KR); Yeo-Jin Yun, Hwaseong-si (KR); Sang-Wook Yoo, Hwaseong-si (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 11/970,053

(22) Filed: Jan. 7, 2008

(30) Foreign Application Priority Data
Jan. 6, 2007 (KR) 10-2007-0001819
Jan. 6, 2007 (KR) 10-2007-0001820
Jan. 6, 2007 (KR) 10-2007-0001821

(51) Int. Cl. G09G 3/36

(52) U.S. Cl. 345/98

(57) ABSTRACT

A liquid crystal display (“LCD”) for eliminating an afterimage includes a power supply, a gate driver and a discharger. The power supply detects the cutting off of external power voltage and supplies a discharge signal. The gate driver simultaneously supplies a gate driving signal to a plurality of gate lines in response to the discharge signal, and the discharger supplies a common voltage to a plurality of data lines in response to the discharge signal.

This application claims priority to Korean Patent application Nos. 2007-0001819, 2007-0001820, and 2007-0001821, filed on Jan. 6, 2007, and all the benefits accruing therefrom under 35 U.S.C. §119, the contents of which in their entireties are herein incorporated by reference.

### BACKGROUND OF THE INVENTION

1. Field of the Invention

The present invention relates to a liquid crystal display (“LCD”) and a method for eliminating an afterimage thereof, and more particularly to an LCD for eliminating an afterimage at the time of cutting off external power and a method thereof.

2. Description of the Related Art

An LCD displays images using light transmittance of a liquid crystal interposed between a first substrate and a second substrate that varies when a voltage is applied to electrodes of the two substrates facing each other to generate an electric field.

With the characteristics of slim profile, light weight, low power consumption and high reliability, the LCDs are being widely used in mobile devices such as personal digital assistants (“PDAs”), mobile phones, and notebook computers which have been rapidly demanded.

When a battery of the LCD for the mobile devices is removed by a user or an external impact, the power to be supplied to the LCD is cut off, to stop the operation thereof. Therefore, afterimages may be left on the liquid crystal panel.

### BRIEF SUMMARY OF THE INVENTION

The present invention provides a liquid crystal display (“LCD”) for eliminating an afterimage by driving all gate lines at the same time and inputting a common voltage to data lines, and a method thereof.

In addition, the present invention provides a data driving device for discharging an electric charge remaining at a driver integrated circuit (“IC”) when a power supply is abnormally stopped, and an LCD using the same.

Exemplary embodiments of the present invention provide an LCD including a power supply which detects cutoff of external power supply voltage and applies a discharge signal related to detection of the cutoff of the external power supply voltage, a gate driver which simultaneously supplies a gate driving signal to a plurality of gate lines in response to the discharge signal, and a discharger which supplies a common voltage to a plurality of data lines in response to the discharge signal.

Other exemplary embodiments of the present invention provide an LCD including a liquid crystal panel having a plurality of gate lines, a plurality of data lines, a plurality of pixel capacitors to which a common voltage is applied and a plurality of thin film transistors (“TFTs”) connecting the data lines to the pixel capacitors in response to a gate driving signal supplied to the gate lines, a timing controller which supplies a data signal, a data control signal and a gate control signal in response to an external signal, a power supply which receives an external power supply voltage, to generate a driving voltage and the common voltage and detects cutoff of the external power supply voltage, to supply a discharge signal related to detection of the cutoff of the external power supply voltage, a gate driver which simultaneously supplies the gate driving signal to the plurality of gate lines in response to the discharge signal, and a first discharger which supplies the common voltage to the plurality of data lines in response to the discharge signal.

Still other exemplary embodiments of the present invention provide a method for eliminating an afterimage of an LCD device, which includes a plurality of gate lines, a plurality of data lines, a plurality of pixel capacitors, each formed relative to an intersection of a gate line and a data line and having a first end to which a common voltage is applied, and a plurality of TFTs for connecting the data lines to second ends of the pixel capacitors in response to a gate driving signal supplied to the gate lines. The method includes detecting a cutoff of external power supply voltage and supplying a discharge signal related to detection of the cutoff of the external power supply voltage, simultaneously supplying the gate driving signal to the plurality of gate lines in response to the discharge signal, and supplying the common voltage to the plurality of data lines in response to the discharge signal.

### BRIEF DESCRIPTION OF THE DRAWINGS

Exemplary embodiment of the present invention can be understood in more detail from the following descriptions taken in conjunction with the accompanying drawings, in which:

FIG. 1 is a block diagram showing an exemplary LCD according to an exemplary embodiment of the present invention;

FIG. 2 is a circuit diagram showing an exemplary discharger shown in FIG. 1;

FIG. 3 is a circuit diagram showing an exemplary output buffer shown in FIG. 1;

FIG. 4 is a circuit diagram showing an exemplary power-off detector shown in FIG. 1;

FIG. 5 is a timing diagram for describing an exemplary operation of the exemplary LCD shown in FIG. 1;

FIG. 6 is a circuit diagram showing another exemplary discharger shown in FIG. 1;

FIG. 7 is a circuit diagram showing another exemplary output buffer shown in FIG. 1;

FIG. 8 is a block diagram showing an exemplary LCD according to another exemplary embodiment of the present invention; and

FIG. 9 is a circuit diagram showing an exemplary discharger shown in FIG. 8.

### DETAILED DESCRIPTION OF THE INVENTION

When the power to be supplied to a conventional LCD is cut off, afterimages are left on the liquid crystal panel. According to the present invention, it is determined that when the power supply is suddenly stopped in the conventional LCD, such as by battery removal, all gate lines except the gate line selected just before the battery was removed are in a gate-off voltage state, maintaining a gray scale voltage accumulated at pixel capacitors of a liquid crystal panel as it is. That is to say, except the gate line selected right before the battery was removed, the paths through which the gray scale voltage accumulated at the pixel capacitors can be discharged are cut off, whereby the gray scale voltage is maintained and left as afterimages until all the gray scale voltages are naturally discharged by leakage current.

However, it is further determined according to the present invention that TFTs formed at the liquid crystal panel in the conventional LCD may have different leakage currents due to the characteristic differences generated during the process, for example, the process variability of the threshold voltage (Vth) of the TFTs. This may result in different discharging states of the pixel capacitors, causing a noise.

It is additionally determined according to the present invention that if the battery is removed and the power supply is thereby suddenly stopped in the conventional LCD, the coding program of scanning white patterns to the gate lines and then cutting off the current supply of a power supply terminal of a driver integrated circuit (“IC”) can not operate normally. Therefore, abnormal pattern afterimages may occur due to an undesirable operation like the driving of the data lines on the liquid crystal panel by an electric charge remaining in the driver IC.

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” an other element, it can be directly on the other element or intervening elements ma y be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

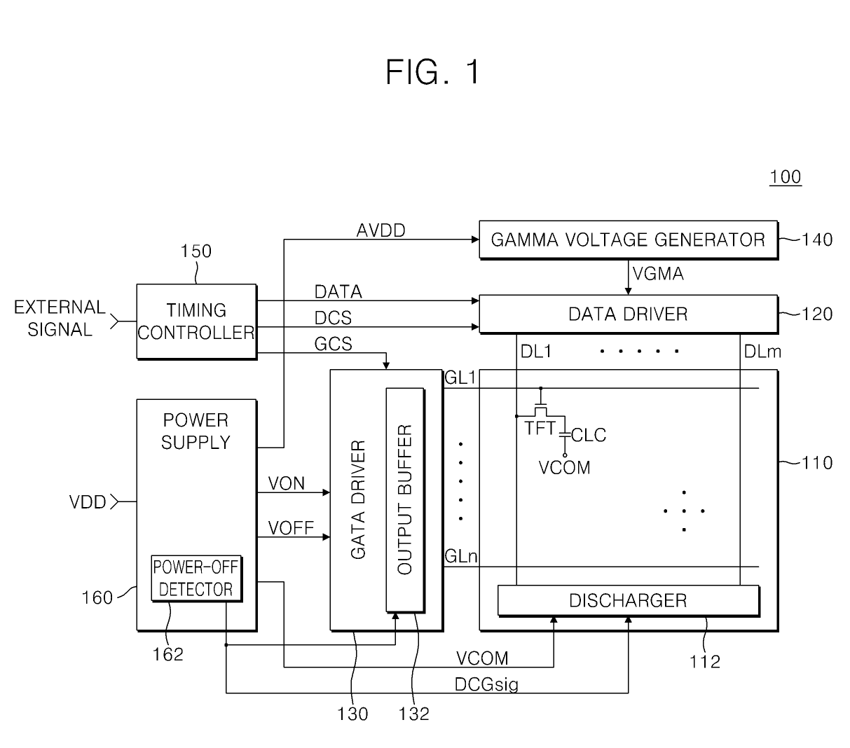

FIG. 1 is a block diagram showing an exemplary LCD according to an exemplary embodiment of the present invention. As shown in FIG. 1, the LCD 100 according to an exemplary embodiment of the present invention includes a liquid crystal panel 110, a data driver 120, a gate driver 130, a gamma voltage generator 140, a timing controller 150 and a power supply 160.

The liquid crystal panel 110 includes a color filter substrate on which a color filter and a common electrode are formed, a TFT substrate on which TFTs are formed, and liquid crystal filled between the color filter substrate and the TFT substrate.

The TFT substrate includes a plurality of gate lines GL1, . . . , GLn, a plurality of data lines DL1, . . . , DLm, a plurality of pixel capacitors CLC which are formed relative to the intersections of the gate lines GL1, . . . , GLn and the data lines DL1, . . . DLm to charge a gray scale voltage, and a plurality of TFTs for supplying the gray scale voltage to the pixel capacitors CLC in response to a gate-on voltage VON. Each TFT has a gate, such as a gate electrode, connected to a gate line GL, a source, such as a source electrode, connected to a data line DL and a drain, such as a drain electrode, connected to a pixel electrode of the pixel capacitor CLC, such that a first end of each pixel capacitor CLC may receive a data signal from the respective TFT. Each pixel capacitor CLC further receives a common voltage VCOM applied to a second end thereof via the common electrode formed on the color filter substrate.

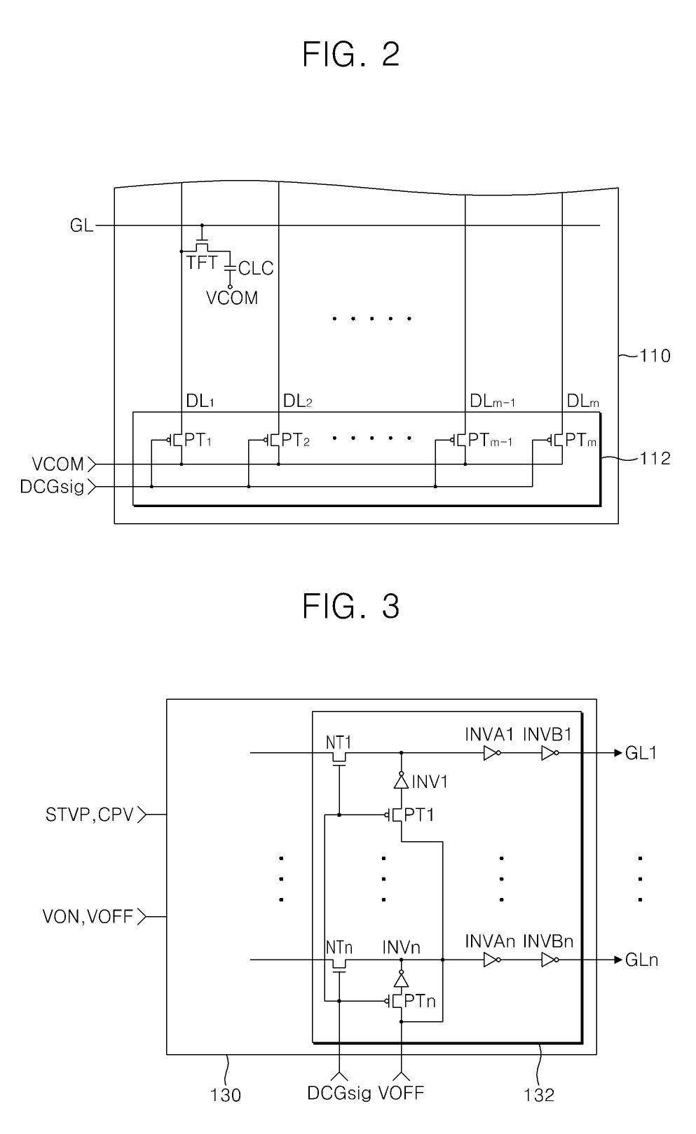

The liquid crystal panel 110 includes a discharger 112 connected to the data lines DL1, . . . , DLm at a non-display region. The discharger 112 is provided with a common voltage VCOM from the power supply 160 and a discharge signal DCGsig (also shown in FIG. 2) from a power-off detector 162. The discharger 112 supplies the common voltage VCOM to a plurality of data lines DL1, . . . , DLm in response to the discharge signal DCGsig when the external power supply voltage VDD is cut off, for example, when a battery is removed from a mobile device having the LCD 100.

The data driver 120 generates the gray scale voltage corresponding to a data signal DATA by using the gamma voltage VGMA, applies the gray scale voltage to the TFT which is driven by the gate-on voltage VON, and displays the gray scale voltage in the unit of the gate line GL1, . . . , GLn.

The data driver 120 is provided with a data control signal DCS and the data signal DATA from the timing controller 150 and the gamma voltage VGMA from the gamma voltage generator 140. The gray scale voltage is an analog voltage corresponding to the data signal DATA, and the data control signal DCS includes a data start pulse STH and a data synchronizing clock CPH.

The data driver 120 may be manufactured in a data driving integrated circuit (“IC”) so that it can be attached to the liquid crystal panel 110 in a tape carrier package (“TCP”) type and directly mounted on the non-display region of the liquid crystal panel 110 in a chip-on-glass (“COG”) type.

The gate driver 130 sequentially supplies the gate driving signal to the gate lines GL1, . . . , GLn and turns on a plurality of TFTs connected to the selected gate lines GL1, . . . , GLn. The gate driver 130 is provided with the gate control signal GCS from the timing controller 150 and the gate-on voltage VON and the gate-off voltage VOFF from the power supply 160. The gate control signal GCS includes a gate start pulse STV, a gate synchronizing clock CPV and an output enable signal OE.

The gate driver 130 has an output buffer 132 which simultaneously supplies the gate driving signal to a plurality of gate lines GL1, . . . , GLn in response to the discharge signal DCGsig if the external power supply voltage VDD is cut off. For this, the output buffer 132 is provided with the discharge signal DCGsig and the gate-off voltage VOFF from the power-off detector 162.

The gate driver 130 may be manufactured in a gate driving IC so that it can be attached to the liquid crystal panel 110 in the TCP type and integrated in the non-display region of the liquid crystal panel 110 in an amorphous silicon gate (“ASG”) type.

The gamma voltage generator 140 divides an analog power supply voltage AVDD supplied from the power supply 160, and generates and supplies the gamma voltage VGMA to the data driver 120.

The timing controller 150 converts an external signal into the data signal DATA which can be processed by the data driver 120, to supply it to the data driver 120, and generates control signals DCS and GCS required in the operation of the data driver 120 and the gate driver 130, to supply them to the data driver 120 and the gate driver 130, respectively. The external signal includes R, G, B data, a synchronizing signal and a clock.

The power supply 160 receives the power supply voltage VDD from an external source, generates the gate-on voltage VON and the gate-off voltage VOFF, and supplies them to the gate driver 130. In addition, the power supply 160 generates the analog power supply voltage AVDD and supplies it to the gamma voltage generator 140.

The power supply 160 has the power-off detector 162 which detects whether the external power supply voltage VDD is cut off, generates the discharge signal DCGsig and supplies it to the discharger 112 and the output buffer 132 of the gate driver 130. In an exemplary embodiment, the discharge signal DCGsig maintains a “high” level when the power supply voltage VDD is normally supplied, and is enabled to a “low” level when the power supply voltage VDD is abnormally cut off.

In the LCD according to an exemplary embodiment of the present invention, and as will be further described below, if the external power supply voltage VDD is abnormally cut off, a plurality of gate lines GL1, . . . , GLn are simultaneously driven and the common voltage VCOM is applied to both ends of the pixel capacitor CLC, thereby discharging all the gray scale voltage remaining at the pixel capacitor CLC, to eliminate an afterimage of the LCD 100.

FIG. 2 is a circuit diagram showing an exemplary discharger shown in FIG. 1. As shown in FIG. 2, the discharger 112 is constructed in such a way that can apply the common voltage VCOM to a plurality of data lines DL1, . . . , DLm in response to the discharge signal DCGsig.

The discharger 112 has a plurality of switching transistors PT1, . . . , PTm respectively corresponding to a plurality of data lines DL1, . . . , DLm. Each switching transistor PT has a control terminal to which the discharge signal DCGsig from the power-off detector 162 is supplied, an output terminal connected to the data lines DL1, . . . , DLm, and an input terminal to which the common voltage VCOM from the power supply 160 is supplied. Here, it is preferable that the switching transistors PT1, . . . , PTm are P-channel metal-oxide semiconductor (“PMOS”) transistors.

In operation, when the power supply voltage VDD is normally applied and thus the discharge signal DCGsig is supplied in a “high” level, the plurality of switching transistors PT1, . . . , PTm are turned off, thereby electrically separating the plurality of data lines DL1, . . . , DLm from each other. Therefore, the data driver 120 can normally apply the gray scale voltage to the TFTs respectively connected to the data lines DL1, . . . , DLm.

When the power supply voltage VDD is abnormally cut off and thus the discharge signal DCGsig is supplied in a “low” level, the plurality of switching transistors PT1, . . . , PTm are turned on, thereby electrically connecting a plurality of data lines DL1, . . . , DLm to each other. The switching transistors PT1, . . . , PTm supply the common voltage VCOM from the power supply 160 to the TFTs connected to the data lines DL1, . . . , DLm. That is, the common voltage VCOM is applied to both ends of the pixel capacitors CLC connected to the TFTs, making the electric potential difference between both electrodes, that is, the pixel electrode and the common electrode, of the pixel capacitor CLC zero. Accordingly, the charge remaining at the pixel capacitor CLC does not remain at the pixel capacitor CLC any more, but can be discharged through the data lines DL1, . . . , DLm connected to the TFTs.

FIG. 3 is a circuit diagram showing an exemplary output buffer shown in FIG. 1. As shown in FIG. 3, the output buffer 132 is configured in such a way that can supply the gate driving signal to a plurality of gate lines GL1, . . . , GLn in response to the discharge signal DCGsig.

The output buffer 132 includes a plurality of switching transistors NT1, . . . , NTn respectively corresponding to a plurality of gate lines GL1, . . . , GLn, driving transistors PT1, . . . , PTn, inverters INV1, . . . , INVn, and buffering inverters INVA1, . . . , INVAn; INVB1, . . . , INVBn.

Each of the switching transistors NT1, . . . , NTn has a control terminal to which the discharge signal DCGsig from the power-off detector 162 is supplied, an input terminal connected to the gate driver 130 and an output terminal connected to a respective one of the gate lines GL1, . . . , GLn. In an exemplary embodiment, the switching transistors NT1, . . . , NTn are N-channel metal-oxide semiconductor (“NMOS”) transistors.

The driving transistors PT1, . . . , PTn include control terminals to which the discharge signal DCGsig from the power-off detector 162 is supplied, output terminals connected to input terminals of the inverters INV1, . . . , INVn, and input terminals to which the gate-off voltage VOFF is applied. In an exemplary embodiment, the driving transistors PT1, . . . , PTn are PMOS transistors.

The inverters INV1, . . . , INVn have the input terminals connected to the output terminals of the driving transistor PT1, . . . , PTn and output terminals connected to the output terminals of the switching transistor NT1, . . . , NTn. Thus, the output terminals of the inverters INV1, . . . , INVn are also connected to the gate lines GL1, . . . , GLn.

The buffering inverters INVA1, . . . , INVAn and INVB1, . . . , INVBn include a plurality of inverter pairs INVA and INVB connected to the output terminals of the switching transistors NT1, . . . , NTn.

In operation, when the power supply voltage VDD is normally supplied and thus the discharge signal DCGsig is applied in a “high” level, the switching transistors NT1, . . . , NTn are turned on, whereas the driving transistors PT1, . . . , PTn are turned off. Accordingly, the gate driver 130 sequentially supplies the gate driving signal to the gate lines GL1, . . . , GLn.

When the power supply voltage VDD is abnormally cut off and thus the discharge signal DCGsig is applied in a “low” level, the switching transistors NT1, . . . , NTn are turned off, whereas the driving transistors PT1, . . . , PTn are turned on. The inverters INV1, . . . , INVn simultaneously supply to the gate lines GL1, . . . , GLn the gate driving signal of the gate-on voltage VON level which is a conversion of the gate-off voltage VOFF supplied to the input terminals of the driving transistors PT1, . . . , PTn. Accordingly, the TFTs connected to the gate lines GL1, . . . , GLn are all turned on, and the gray scale voltage stored at the pixel capacitors CLC is discharged through the data lines DL1, . . . , DLm. Thereby, the afterimage generated on the conventional liquid crystal panel due to the abnormal cutoff of the power supply can be eliminated.

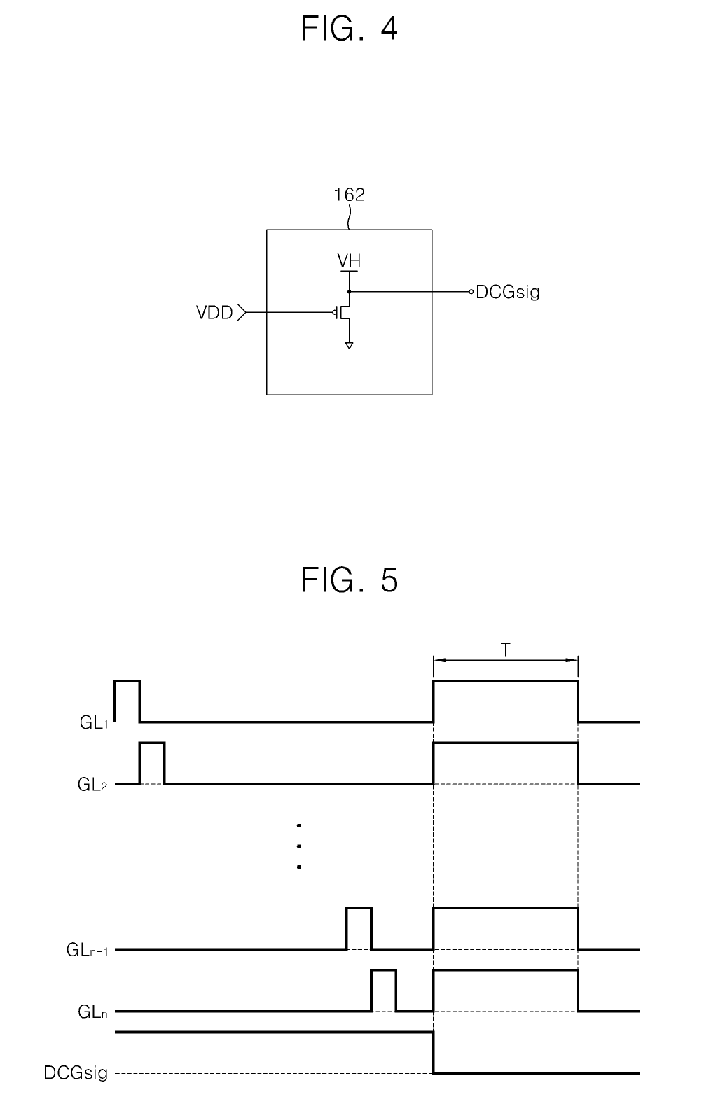

FIG. 4 is a circuit diagram showing an exemplary power-off detector shown in FIG. 1. As shown in FIG. 4, the power-off detector 162 is configured to generate the discharge signal DCGsig in response to the external power supply voltage VDD.

The power-off detector 162 includes a signal generating transistor generating the discharge signal DCGsig. The signal generating transistor has a source connected to a power supply terminal, a drain connected to a ground terminal, and a gate to which the external power supply voltage VDD is applied. A voltage VH corresponding to a high level of the discharge signal DCGsig, for example, the power supply voltage VDD, may be applied to the power supply terminal. The source connected to the power supply terminal operates as an output terminal from which the discharge signal DCGsig is output. In an exemplary embodiment, the signal generating transistor is a PMOS transistor.

In operation, when the power supply voltage VDD is normally supplied, the signal generating transistor in the power-off detector 162 is turned off, and the “high” level voltage supplied to the power supply terminal is output as the discharge signal DCGsig. When the power supply voltage VDD is abnormally cut off, the signal generating transistor in the power-off detector 162 is turned on and a path connecting the power supply terminal to the ground terminal is formed, whereby the currents by the “high” level voltage supplied to the power supply terminal are all flowing into the ground terminal. Accordingly, the “low” level voltage corresponding to the ground terminal is output as the discharge signal DCGsig.

FIG. 5 is a timing diagram for describing the operation of the exemplary LCD shown in FIG. 1. Referring to FIG. 5, in a section where the discharge signal DCGsig is in a “high” level, which corresponds to the section where the power supply voltage VDD is normally supplied, the gate driving signal is sequentially supplied to a plurality of gate lines GL1, . . . , GLn.

In a section where the discharge signal DCGsig is in a “low” level, which corresponds to the section where the power supply voltage VDD is abnormally cut off by removing a battery or the like, the gate driving signal is applied to a plurality of gate lines GL1, . . . , GLn simultaneously by the output buffer 132.

T denotes the time during which the gate driving signal applied to a plurality of gate lines GL1, . . . , GLn by the output buffer 132 maintains the “high” level. In an exemplary embodiment, T is the time during which all charges accumulated at all pixel capacitors CLC of the liquid crystal panel 110 can be discharged by the driving of a plurality of the gate lines GL1, . . . , GLn.

The LCD according to an exemplary embodiment of the present invention is configured to drive a plurality of gate lines GL1, . . . , GLn simultaneously at the time of abnormal cutoff of the power supply voltage VDD, thereby discharging all the gray scale voltage remaining at the pixel capacitors CLC, to eliminate afterimages on the liquid crystal panel 110.

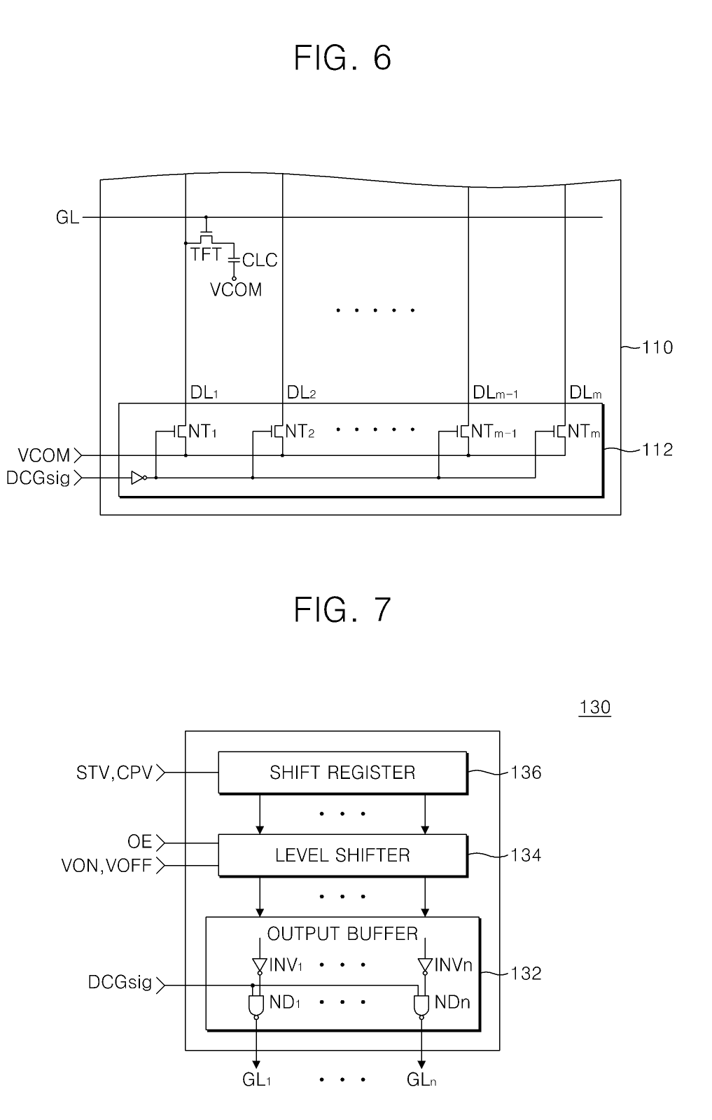

FIG. 6 is a circuit diagram showing another exemplary discharger shown in FIG. 1. As shown in FIG. 6, the discharger 112 is configured to apply the common voltage VCOM from the power supply 160 to a plurality of data lines DL1, . . . , DLm in response to the discharge signal DCGsig supplied by the power-off detector 162.

The discharger 112 includes a plurality of switching transistors NT1, . . . , NTm corresponding to a plurality of data lines DL1, . . . , DLm, and an inverter INV for inverting the phase of the discharge signal DCGsig and then supplying it to the control terminal of each of the switching transistors NT1, . . . , NTm. Here, the output of the inverter INV becomes an inverted discharge signal DCGsigB, or, in other words, a discharge bar signal.

The switching transistors NT1, . . . , NTm include the control terminals to which the inverted discharge signal DCGsigB is applied, output terminals connected to the data lines DL1, . . . , DLm, and input terminals to which the common voltage VCOM is supplied. In an exemplary embodiment, the switching transistors NT1, . . . , NTm are NMOS transistors.

In operation, when the power supply voltage VDD is normally supplied and thus the discharge signal DCGsig is applied in a “high” level, the inverted discharge signal DCGsigB is output in a “low” level from the inverter INV, and the switching transistors NT1, . . . , NTm are turned off, thereby electrically dividing the data lines DL1, . . . , DLm from each other. Accordingly, the data driver 120 can normally apply the gray scale voltage to the TFTs respectively connected to the data lines DL1, . . . , DLm.

When the power supply voltage VDD is abnormally cut off and thus the discharge signal DCGsig is applied in a “low” level, the inverted discharge signal DCGsigB is output in a “high” level from the inverter INV and the switching transistors NT1, . . . , NTm are turned on, thereby electrically connecting the data lines DL1, . . . , DLm to each other. The switching transistors NT1, . . . , NTm supply the common voltage VCOM, applied to the input terminals of the switching transistors NT1, . . . NTm, to the TFTs respectively connected to the data lines DL, . . . , DLm. Accordingly, both electrodes of each pixel capacitor CLC connected to the TFT, that is, the common electrode and the pixel electrode, are provided with the common voltage VCOM, thereby simultaneously eliminating the accumulated gray scale voltage.

FIG. 7 is a block diagram showing a construction of the exemplary gate driver shown in FIG. 1. As shown in FIG. 7, the gate driver 130 includes a shift register 136, a level shifter 134 and an output buffer 132.

The shift register 136 sequentially generates the gate driving signal in response to the control signals STV and CPV supplied from the timing controller 150. The control signal STV is a vertical synchronizing signal for informing the start of one frame, and the control signal CPV is a clock signal.

The level shifter 134 level-shifts the gate driving signal supplied from the shift register 136 into the gate-on voltage VON level and the gate-off voltage VOFF level. The level shifter 134 can control the characteristic of the gate driving signal generated from the shift register 136, for example, the pulse width thereof by using the output enable signal OE which is a gate control signal GCS.

The output buffer 132 is configured in such a way that can sequentially supply the gate driving signal supplied from the level shifter 134 to a plurality of gate lines GL1, . . . , GLn or simultaneously supply the gate driving signal from the level shifter 134 to a plurality of gate lines GL1, . . . , GLn.

The output buffer 132 includes inverters INV1, . . . , INVn for inverting the phase of the gate driving signal from the level shifter 134 and enhancing the current driving capacity. The output buffer 132 further includes a plurality of NAND gates ND1, . . . , NDn performing a NAND operation of outputs of the inverters INV1, . . . , INVn and the discharge signal DCGsig and supplying the operation results to corresponding gate lines GL1, . . . , GLn.

Table 1 is a truth table showing the logic operation result of the NAND gates ND1, . . . , NDn according to the output signal of the inverters INV1, . . . , INVn, and the discharge signal DCGsig.

TABLE 1

| Output signal | | Output signal |
|---|---|---|
| of inverter | Discharge signal | of NAND gate |
| 0 | 0 | 1 |
| 1 | 0 | 1 |
| 0 | 1 | 1 |
| 1 | 1 | 0 |

In Table 1, if the output signal of the inverter INV1, . . . , INVn is “0”, this means that a corresponding gate line is selected by the shift register 136, whereas if the output signal of the inverter INV1, . . . , INVn is “1”, this means that a corresponding gate line is not selected by the shift register 136.

When the output signal of the NAND gate is “1”, this means that the gate driving signal of the gate-on voltage VON level is supplied to a corresponding gate line, whereas if the output signal of the NAND gate is “0”, this means that the gate driving signal of the gate-off voltage VOFF level is supplied to a corresponding gate line.

When the discharge signal is “0”, such as a discharge signal DCGsig in a low level, this means that the battery was removed and thus the external power supply voltage VDD is cut off, whereas if the discharge signal is “1”, such as a discharge signal DCGsig in a high level, this means that the external power supply voltage VDD is normally supplied.

When the external power supply voltage VDD is normally supplied, so that the discharge signal is “1”, the output buffer 132 according to an exemplary embodiment of the present invention, inverts the output signal of the inverters INV1, . . . , INVn by the NAND gates ND1, . . . , NDn, thereby sequentially supplying the gate driving signal to a plurality of gate lines GL1, . . . , GLn. In other words, the TFTs connected to the plurality of gate lines GL1, . . . , GLn are either turned on or off depending on the discharge signal DCGsig.

When the external power supply voltage VDD is cut off, the NAND gates ND1, . . . , NDn always supply “1”, that is, the gate driving signal of the gate-on voltage VON level is simultaneously supplied to a plurality of gate lines GL1, . . . , GLn regardless of the output signal of the inverters INV1, . . . , INVn. Accordingly, all TFTs connected to a plurality of gate lines GL1, . . . , GLn are turned on, thus forming a path through which the gray scale voltage remaining at the pixel capacitors CLC can be discharged. Thereby, the afterimages generated on the conventional liquid crystal panel due to the abnormal cutoff of the power can be eliminated.

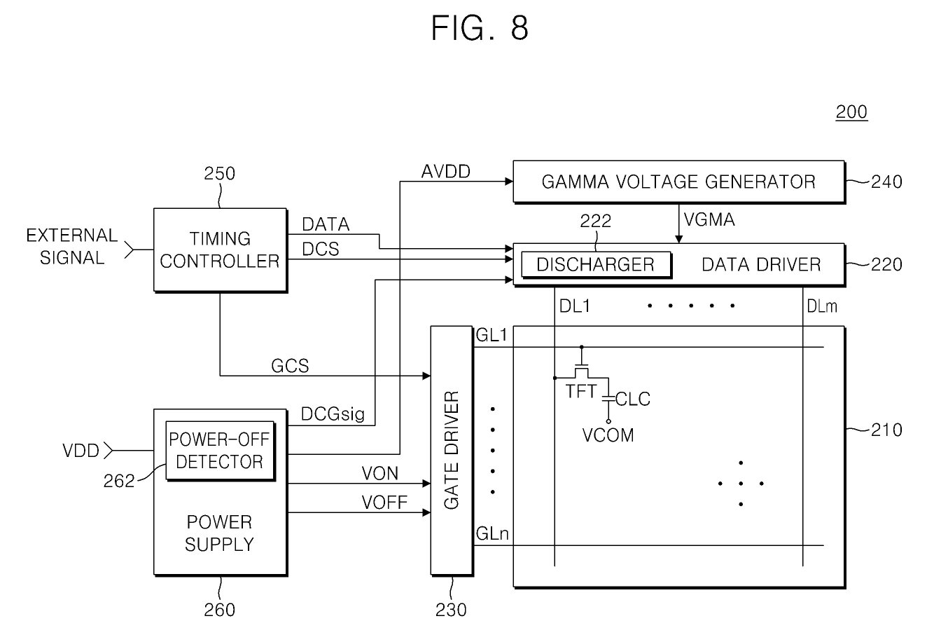

FIG. 8 is a block diagram showing an exemplary LCD according to another exemplary embodiment of the present invention. As shown in FIG. 8, a data driver 220 of the LCD 200 according to another exemplary embodiment of the present invention includes a discharger 222 for cutting off the supply of the data signal DATA from a timing controller 250 and the supply of the gamma voltage VGMA from a gamma voltage generator 240 in response to the discharge signal DCGsig from a power-off detector 262, and discharging the charge remaining at the data driver 220.

The power supply 260 of the LCD 200 according to another exemplary embodiment of the present invention includes the power-off detector 262 for detecting the abnormal cutoff of the power supply voltage VDD. The power-off detector 262 detects that the power supply voltage VDD is abnormally cut off, to generate the discharge signal DCGsig, and supplies the discharge signal DCGsig to the discharger 222 of the data driver 220. The abnormal cutoff of the external power supply voltage VDD refers to, for example, the case where the battery is removed from the mobile device to which the LCD 200 is applied by a user or an external impact, and the like.

Therefore, the discharger 222 can cut off the supply of the data DATA and the gamma voltage VGMA in response to the discharge signal DCGsig and discharge the charge remaining at the data driver 220.

The constructions and operations of the other components of the LCD 200, such as the liquid crystal panel 210, the gate driver 230, the gamma voltage generator 240, the timing controller 250, and the power supply 260 may be identical or substantially identical to corresponding elements described with respect to FIG. 1, and thus detailed descriptions thereof will be omitted.

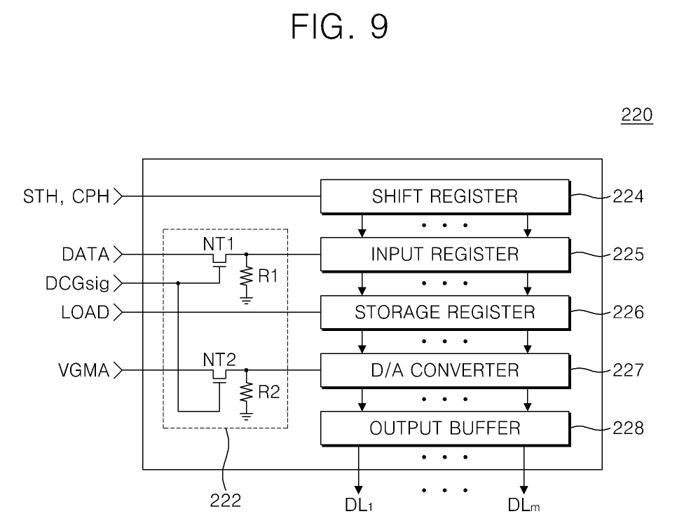

FIG. 9 is a circuit diagram showing an exemplary discharger within an exemplary data driver shown in FIG. 8. As shown in FIG. 9, the data driver 220 includes a shift register 224, an input register 225, a storage register 226, a digital-to-analog (“D/A”) converter 227, an output buffer 228 and the discharger 222.

The shift register 224 receives the data start signal STH and the data synchronizing clock CPH, to generate a sampling signal and then supplies the sampling signal to the input register 225. More specifically, the shift register 224 shifts the data start signal STH per one period of the data synchronizing clock CPH, and generates n sampling signals.

The input register 225 sequentially stores the data signal DATA in response to the sampling signals which are sequentially input from the shift register 224. More specifically, the input register 225 stores the data signal DATA corresponding to one line in response to the sampling signal.

When a load signal LOAD is input, the storage register 226 receives and stores simultaneously the data signal DATA as much as one line stored at the input register 225. The load signal LOAD functions to simultaneously apply the gray scale voltage corresponding to one line of data signal DATA to a plurality of pixel capacitors CLC connected to one gate line.

The D/A converter 227 generates the gray scale voltage corresponding to the data signal DATA value by using the gamma voltage VGMA and then supplies the gray scale voltage to the output buffer 228. The output buffer 228 simultaneously supplies the gray scale voltage supplied from the D/A converter 227 to the data lines DL1, . . . DLm.

The discharger 222 switches the data signal DATA supplied to the input resister 225 and the gamma voltage VGMA supplied to the D/A converter 227 in response to the discharge signal DCGsig, and provides a path through which the charge remaining at the input register 225 and the D/A converter 227 can be discharged.

The discharger 222 includes a first switching transistor NT1, a first ground path resistance R1, a second switching transistor NT2 and a second ground path resistance R2.

The first switching transistor NT1 has an input terminal to which the data signal DATA is supplied, a control terminal to which the discharge signal DCGsig is supplied and an output terminal connected to the input register 225. One end of the first ground path resistance R1 is connected to the output end of the first switching transistor NT1 and to the input register 225 and the other end thereof is connected to a ground terminal.

The second switching transistor NT2 has an input terminal to which the gamma voltage VGMA is supplied, a control terminal to which the discharge signal DCGsig is supplied and an output terminal connected to the D/A converter 227. One end of the second ground path resistance R2 is connected to the output terminal of the second switching transistor NT2 and to the D/A converter 227 and the other end thereof is connected to the ground terminal.

In operation, when the power supply voltage VDD is normally supplied and thus the discharge signal DCGsig is applied in a “high” level, the first and second switching transistors NT1 and NT2 are turned on, thereby normally supplying the data signal DATA and the gamma voltage VGMA to the input register 225 and the D/A converter 227, respectively. Since the data signal DATA and the gamma voltage VGMA have comparatively higher voltage levels than the input register 225 and the D/A converter 227, the data signal DATA and the gamma voltage VGMA can be supplied to the input register 225 and the D/A converter 227 regardless of the first and second ground path resistances R1 and R2.

When the power supply voltage VDD is abnormally cut off and thus the discharge signal DCGsig is applied in a “low” level, the first and second switching transistors NT1 and NT2 are turned off, thereby cutting off the supply of the data signal DATA and the gamma voltage VGMA to the input register 225 and the D/A converter 227. In this case, the output terminals of the first and second switching transistors NT1 and NT2 have comparatively lower voltage levels than the input register 225 and the D/A converter 227.

Therefore, the charge remaining at the input register 225 and the D/A converter 227 is bypassed to the first and second ground path resistances R1 and R2, respectively. Accordingly, if the power supply voltage VDD is abnormally cut off, the charge remaining at the input register 225 and the D/A converter 227 can be forcibly discharged through the ground terminal.

The LCD and method for eliminating an afterimage of the present invention has an effect of eliminating the afterimage generated at the time of removal of a battery by, if it is detected that the battery was removed, driving all gate lines simultaneously and inputting the common voltage to the data lines, in exemplary embodiments thereof.

In addition, since the LCD of the present invention can discharge the charge remaining at the driver IC when the power supply is abnormally cut off, it has an effect of eliminating abnormal patterns and afterimages due to the charge remaining at the driver IC even when the power supply is abnormally cut off and thus the program for cutting off the flow of the current to the power supply terminal of the driver IC cannot operate.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A liquid crystal display comprising:
a power supply which detects cutoff of external power supply voltage and applies a discharge signal;
a gate driver which simultaneously supplies a gate driving signal to a plurality of gate lines in response to the discharge signal; and
a discharger which supplies a common voltage to a plurality of data lines in response to the discharge signal.

2. The liquid crystal display according to claim 1, wherein the gate driver comprises:
a plurality of driving transistors which respectively correspond to the gate lines and which supply a gate-off voltage in response to the discharge signal; and
inverters which convert a phase of the gate-off voltage and which supply a converted phase of the gate-off voltage to the gate lines as the gate driving signal.

3. The liquid crystal display according to claim 2, wherein the discharger comprises a plurality of switching transistors respectively corresponding to the plurality of data lines, and the switching transistors supply the common voltage to the data lines in response to the discharge signal.

4. The liquid crystal display according to claim 1, wherein the power supply comprises a signal generating transistor connected to a power supply terminal to which a power supply voltage is applied and to a ground terminal to which a ground voltage is applied, wherein the signal generating transistor switches the power supply voltage applied to the power supply terminal and the ground voltage applied to the ground terminal in response to supply of the external power supply voltage and supplies the discharge signal.

5. The liquid crystal display according to claim 1, wherein the gate driver comprises:
a plurality of NAND gates which supply the gate driving signal; and
a plurality of first inverters corresponding to the plurality of NAND gates and inverting a phase of the gate driving signal, and
the NAND gates perform a NAND operation of an output of the first inverters and the discharge signal and supply an operation result as the gate driving signal.

6. The liquid crystal display according to claim 5, wherein the discharger comprises:
a plurality of switching transistors respectively corresponding to the plurality of data lines; and
a second inverter which inverts a phase of the discharge signal and outputs an inverted phase of the discharge signal as a discharge bar signal, and
the switching transistors supply the common voltage to the data lines in response to the discharge bar signal.

7. The liquid crystal display of claim 1, wherein the gate driver simultaneously supplies the gate driving signal to the plurality of gate lines for a time period during which substantially all charges accumulated at pixel capacitors of the liquid crystal display are discharged.

8. The liquid crystal display of claim 7, wherein a first end of the pixel capacitors receive the common voltage from a common electrode, and a second end of the pixel capacitors receive the common voltage from the plurality of data lines in response to the discharge signal, and substantially all gray scale voltage at the pixel capacitors are discharged.

9. A liquid crystal display comprising:
a liquid crystal panel having a plurality of gate lines, a plurality of data lines, a plurality of pixel capacitors to which a common voltage is applied and a plurality of thin film transistors connecting the data lines to the pixel capacitors in response to a gate driving signal supplied to the gate lines;
a timing controller which supplies a data signal, a data control signal and a gate control signal in response to an external signal;
a power supply which receives an external power supply voltage, to generate a driving voltage and the common voltage and detects cutoff of the external power supply voltage, to supply a discharge signal related to detection of the cutoff of the external power supply voltage;
a gate driver which simultaneously supplies the gate driving signal to the plurality of gate lines in response to the discharge signal; and
a first discharger which supplies the common voltage to the plurality of data lines in response to the discharge signal.

10. The liquid crystal display according to claim 9, wherein the gate driver comprises:
a plurality of first switching transistors which respectively correspond to the plurality of gate lines and supply the gate driving signal to the gate lines in response to the discharge signal;
a plurality of driving transistors which respectively correspond to the gate lines and supply a gate-off voltage in response to the discharge signal; and
inverters which invert a phase of an output of the driving transistors and which supply an inverted phase of the output of the driving transistors to the gate lines.

11. The liquid crystal display according to claim 10, wherein the first discharger comprises:
a plurality of second switching transistors which respectively correspond to the plurality of data lines; and
a second inverter which inverts a phase of the discharge signal and outputs an inverted phase of the discharge signal as a discharge bar signal, and
the second switching transistors switch the common voltage to the data lines in response to the discharge bar signal.

12. The liquid crystal display according to claim 9, wherein the gate driver comprises:
a plurality of NAND gates which supply the gate driving signal; and
a plurality of first inverters which correspond to the plurality of NAND gates and invert a phase of the gate driving signal, and
the NAND gates perform a NAND operation of an output of the first inverters and the discharge signal and supply an operation result as the gate driving signal.

13. The liquid crystal display according to claim 12, wherein the first discharger comprises:
a plurality of switching transistors which respectively correspond to the plurality of data lines; and
a second inverter which inverts a phase of the discharge signal and outputs an inverted phase of the discharge signal as a discharge bar signal, and
the switching transistors supply the common voltage to the data lines in response to the discharge bar signal.

14. The liquid crystal display according to claim 9, further comprising:
a gamma voltage generator which divides the driving voltage, to generate a gamma voltage; and
a data driver which switches the data signal and the gamma voltage in response to the discharge signal and discharges remaining charge.

15. The liquid crystal display according to claim 14, wherein the data driver comprises:
a shift register which generates a sampling signal in response to the data control signal;
an input register which sequentially stores the data signal in response to the sampling signal;
a storage register which simultaneously stores the data signal supplied from the input register in response to the data control signal;
a digital-to-analog converter which generates a gray scale voltage corresponding to the data signal by using the gamma voltage;
an output buffer which supplies the gray scale voltage to the liquid crystal panel; and
a second discharger which switches supply of the data signal and the gamma voltage in response to the discharge signal and discharges the remaining charge at the input register and the digital-analog converter.

16. The liquid crystal display according to claim 15, wherein the second discharger comprises:
a first switching transistor which supplies the data signal to the input register in response to the discharge signal; and
a first ground path resistance, a first end of the first ground path resistance connected to an output end of the first switching transistor and a second end of the first ground path resistance connected to a ground terminal.

17. The liquid crystal display according to claim 16, wherein the second discharger further comprises:
a second switching transistor which supplies the gamma voltage to the digital-analog converter in response to the discharge signal; and
a second ground path resistance, a first end of the second ground path resistance connected to an output end of the second switching transistor and a second end of the second ground path resistance connected to the ground terminal.

18. A method of driving a liquid crystal display device, the method comprising:
detecting a cutoff of external power supply voltage and supplying a discharge signal related to detection of the cutoff of the external power supply voltage;
simultaneously supplying the gate driving signal to the plurality of gate lines in response to the discharge signal; and
supplying the common voltage to the plurality of data lines in response to the discharge signal.

19. The method according to claim 18, wherein detecting the cutoff of external power supply voltage comprises, if the supply of the external power supply voltage is cut off, enabling and outputting the discharge signal by using a signal generating transistor which has a source that is connected to a power supply terminal and operates as an output end for supplying the discharge signal, a drain connected to a ground terminal, and a gate to which the external power supply voltage is supplied.

20. The method according to claim 19, wherein simultaneously supplying the gate driving signal comprises, if the discharge signal is enabled, inverting a gate-off voltage and supplying it as the gate driving signal.
